(19) United States
(12) Patent Application Publication
(10) Pub. No.: US 2004/0037070 A1
(43) Pub. Date: Feb. 26, 2004

(54) Hinge pin puller accessory and kit

(76) Inventor: Michael Schubach, Dos Hermanos, CA (US)

Correspondence Address: Michael G. Petit, P.O. Box 91929, Santa Barbaara, CA, 93190-1929, US

(21) Appl. No.: 10/225,730

(22) Filed: Aug. 21, 2002

(51) Int. Cl. F21S 8/00; F21V 21/00

(52) U.S. Cl. 362/190; 362/145; 362/382

(57) ABSTRACT

A device for attachment to a hinge pin to facilitate removal of the hinge pin from a hinge assembly. The device is a graspable three-dimensional body having a base portion with a recess therein adapted to matingly engage the expanded head of a hinge pin. In one embodiment, the base portion is affixed to the expanded head of the hinge pin by adhesive means. In another embodiment, the base portion includes a recurved flange with a slot therein that seats between the expanded head of the hinge pin and the upper end of the hinge pieces. After the three-dimensional body is affixed to the hinge pin, manual traction on the three-dimensional body enables the hinge pin to be removed from the hinge assembly without the use of tools. Preferably, the three-dimensional body is sculpted to provide an object of art. The three-dimensional body may be painted with a phosphor or include a light source such as LED powered by a battery to provide a door hinge-mounted night light. A kit for installing the three-dimensional body includes a three-dimensional body, adhesive and, optionally, an adapter and/or an offset adapter.

### BACKGROUND OF THE INVENTION

1. Field of the Invention

The present invention relates generally to hinge assemblies and, more particularly to a device for removing a hinge pin from a hinge assembly.

2. Prior Art

A door is usually attached to a door frame via a hinge assembly comprising two mating “knuckled” hinge pieces, one of which is affixed to the door frame and the other piece affixed to the door. The hinge pieces fit together in mating engagement to form a cylindrical channel dimensioned to receive a hinge pin. The hinge pin has an expanded head and an elongate cylindrical stem extending downwardly from the head through the cylindrical channel. The hinge pin settles under gravity until the expanded head is adjacent to a top end of the cylindrical channel. The hinge pin holds the two hinge pieces together while allowing the hinge pieces to rotate about an axis defined by the stem of the hinge pin.

In accordance with the prior art, the hinge pin is removed by inserting a nail or screwdriver into the bottom opening of the cylindrical channel so that it makes contact with the bottom of the hinge pin stem, and then driving the hinge pin up and out of the channel formed by the juxtaposed hinge pieces. Often a hammer is used to apply impact pressure against the nail or screwdriver to drive the hinge pin out of the channel. Once the hinge pin has been slightly removed from the channel, a person can grasp the hinge pin and pull it out either by hand or by using a grasping device such as pliers.

A problem that arises when removing hinge pins in this fashion is that the screwdriver or the nail that is inserted into the channel can damage the hinge pin or the hinge pieces. For example, if the nail or screwdriver is positioned adjacent the surface of the hinge pieces and the hinge pin, hammering on the nail or screw may result in gouges being formed in either the outer surface of the hinge pin, the inner surfaces of the hinge pieces, or both. Damage of this type may make subsequent installation of the hinge pin into the channel more difficult. Further, it will be appreciated that hammering a nail or a screwdriver in this fashion results in the hammer being swung substantially adjacent the door. A mis-hit of the screwdriver or nail can result in the hammer damaging the door or the hinge assembly, so as to mar its appearance.

Alternatively, in some circumstances it may be possible to use pliers to remove the hinge pin without running the risk of damaging the door or hinge assembly. Unfortunately, most hinge pins are usually flushly positioned within the channel in the hinge pieces, and the portion of the stem adjacent the expanded head of the hinge pin often has a diameter that is slightly larger than the diameter of the channel so that the hinge pin has to be forced into the channel and is securely retained therein. In such an instance, it is often difficult to use pliers to successfully extract the hinge pin.

To address the problems associated with removing hinge pins from hinges, several hinge pin removing devices have been developed. Representative tools for removing a hinge pin from a hinge assembly are disclosed in U.S. Pat. No. 3,689,977 to Crabbe, U.S. Pat. No. 4,188,701 to Ludwig, Des. Pat. No. 419,848 to Kirby, U.S. Pat. No. 5,875,535 to Canoy, U.S. Pat. No. 4,720,904 to Palla, Jr. and U.S. Pat. No. 6,256,855 to Schall. The need for all of the foregoing tools for the removal of a hinge pin is necessary due to the construction of the hinge pin employed in the hinge assembly. There is a need for a hinge pin accessory that may be permanently affixed to a hinge pin that is both decorative and that enables the hinge pin to be removed from a hinge assembly without the use of tools. There is a further need for a hinge pin accessory that provides a source of light for directional orientation in a darkened room.

### SUMMARY

A kit is disclosed that comprises a decorative three-dimensional body having a base portion adapted to be attached to the expanded head of a hinge pin, and adhesive means operable for nonreleasably affixing the base portion to the expanded head of the hinge pin. The kit may include an adapter having a top end operable for attachment to the base portion of the three-dimensional body and a bottom end adapted to matingly engage the expanded head of a hinge pin. The present invention also discloses an offset armature that may be used to effectively displace a replica of the expanded head of a hinge pin from the hinge pin comprising a hinge assembly in order to provide space for mounting the three-dimensional body on the hinge pin. In yet another embodiment, the base portion of the three-dimensional body includes a recurved flange extending having a slotted circular aperture therein dimensioned to receive the stem of a hinge pin therewithin. The expanded head of the hinge pin fits within a recess between the base portion and the flange.

In yet a further embodiment, the base portion is separable from the three-dimensional body and the base portion includes a battery compartment therewithin. A battery disposed within the battery compartment is in electrical connection to a source of light such as a LED affixed to the three-dimensional body. In addition to serving as a hinge puller, this embodiment provides a hinge pin-mounted source of light.

In use, the three-dimensional body is permanently affixed to the expanded head of the hinge pin thereafter providing means for grasping the hinge pin for removal from the hinge assembly. As a further benefit, the three-dimensional body may be sculpted to provide an aesthetically pleasing hinge-mounted object of art.

The features of the invention believed to be novel are set forth with particularity in the appended claims. However the invention itself, both as to organization and method of operation, together with further objects and advantages thereof may be best understood by reference to the following description taken in conjunction with the accompanying drawings in which:

### BRIEF DESCRIPTION OF THE DRAWINGS

FIG. 1 is a partially cross-sectional view of a hinge assembly in accordance with the prior art.

FIG. 2 is an elevational view of a first embodiment a three-dimensional body having a base portion adapted to be affixed to the expanded head of a hinge pin.

FIG. 3 is a partially cross-sectional view of a hinge assembly illustrating the three-dimensional body of FIG. 2 affixed to the expanded head of a hinge pin.

FIG. 4 is a transverse cross-sectional view of an adapter operable for reducing or expanding the diameter of the expanded head of a hinge pin to matingly engage a cylindrical recess within the base portion of a three-dimensional body.

FIG. 5 is a partially cross-sectional view of an offset adapter operable for the lateral displacement of the expanded head of a hinge pin to provide space for mounting a three-dimensional body thereon.

FIG. 6 is a side elevational view of a second preferred embodiment of a three-dimensional body wherein the base portion comprises a hinge pin-mounting flange.

FIG. 7 is a rear elevational view of the second preferred embodiment of a three-dimensional body illustrated in FIG. 6.

FIG. 8 is a perspective view of the hinge pin-mounting flange that is affixed to the three-dimensional body as shown in FIGS. 6 and 7.

FIG. 9 is a bottom view of the hinge pin-mounting flange shown in FIG. 8.

FIGS. 10 and 11 are exploded views of two similar embodiments of a three-dimensional body comprising a battery and a light source wherein the base portion of the three-dimensional body is separable from the three-dimensional body and includes a recess dimensioned to receive a battery therewithin and wherein the assembled three-dimensional body provides electrical communication between the poles of the battery and the LED light source.

FIG. 12 shows a pellet comprised of a formable two-part adhesive that may be employed for affixing the base portion of a three-dimensional body to the expanded head of a hinge pin.

### DESCRIPTION OF THE PREFERRED EMBODIMENTS

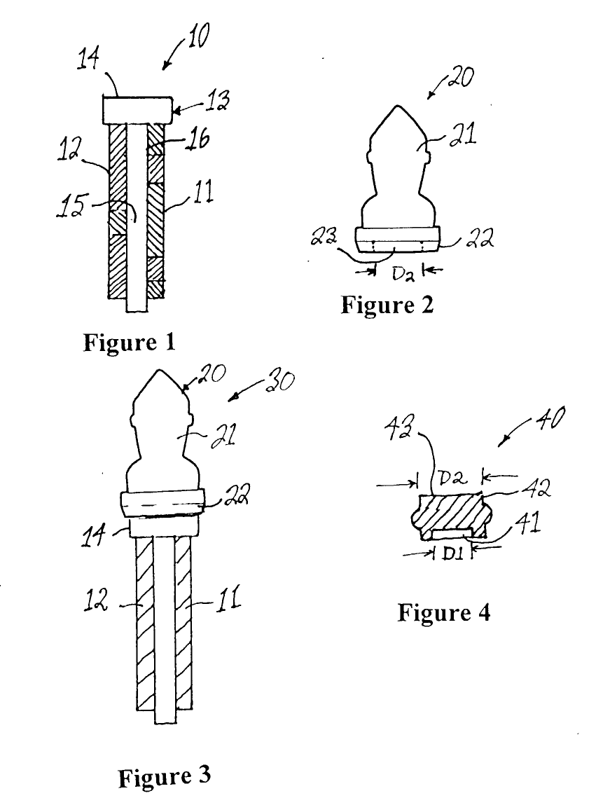

Turning now to FIG. 1, a hinge assembly in accordance with the prior art is indicated at numeral 10. The hinge assembly 10 comprises a jamb-mountable piece 11, a door-mountable piece 12 and a hinge pin 13 having an expanded head 14 and an elongate stem 15 depending downwardly from the expanded head 14. The stem 15 of the hinge pin 13 is received within a cylindrical channel 16 formed between interleaved pieces 111 and 12 of the hinge assembly 10. In accordance with the state of the art (and under the influence of gravity), when the hinge assembly is in use, the expanded head 14 lies flush with the top edge of the hinge pieces 111 and 12 and it is difficult to grasp the expanded head and apply traction thereto in order to remove the stem from within the cylindrical channel without the use of a tool.

To overcome the aforesaid disassembly limitation inherent in prior art hinge assemblies, the present invention discloses an accessory that is adapted to be affixed to the expanded head of a hinge pin. The first preferred embodiment of the accessory is a three-dimensional body indicated at numeral 20 in FIG. 2. The three-dimensional body has a grasping portion 21 and a base portion 22. The base portion 22 has a cylindrical recess 23 therein that has an inner diameter D2 dimensioned to snugly receive a portion of the cylindrical expanded head 14 of the hinge pin therewithin as will be discussed below.

For the purpose of simplicity, and because the construction of prior art hinge assemblies are well understood by the artisan, in the drawings that follow, hinge pieces 11 and 12 are indicated as identical. Nevertheless, it is understood that the two pieces 11 and 12 comprising a hinge assembly are separable and, when juxtaposed, form a cylindrical channel therebetween into which the stem of a hinge pin is inserted to complete the hinge assembly 10. With reference now to FIG. 3, a hinge assembly comprising a three-dimensional body 20 is illustrated in partially cross-sectional view at numeral 30. The base portion 22 of the three-dimensional body is affixed to the upper surface of the expanded head 14 of the hinge pin by adhesive means 120 (FIG. 12) and is integral therewith. The grasping portion 21 of the three-dimensional body 20 may be grasped by fingers and the hinge pin removed from the hinge assembly 30 by application of traction thereto, without the use of tools. In addition to the accessory's utility for removing the hinge pin, the three-dimensional body may be sculpted in many forms in accordance with the owners interest such as birds, planes, trains, mammals etc.

The diameter of the expanded head of prior art hinge pins may vary in accordance with the size of the hinge assembly. A “cap” adapter operable for effectively expanding the diameter of the expanded head of a hinge pin having a diameter D1, which diameter D1 is smaller than the diameter D2 of the cylindrical recess 23 in the base portion 22 of the three-dimensional body 20, is illustrated in cross-sectional view at 40 in FIG. 4. In use, the cylindrical recess 41 in the base of adapter 40 is positioned to receive the expanded head of the hinge pin therewithin and affixed thereto by adhesive means such as the two-part adhesive indicated at 120 in FIG. 12. The three-dimensional body 20 may then be affixed to the top portion 43 of the adaptor 40 as previously described.

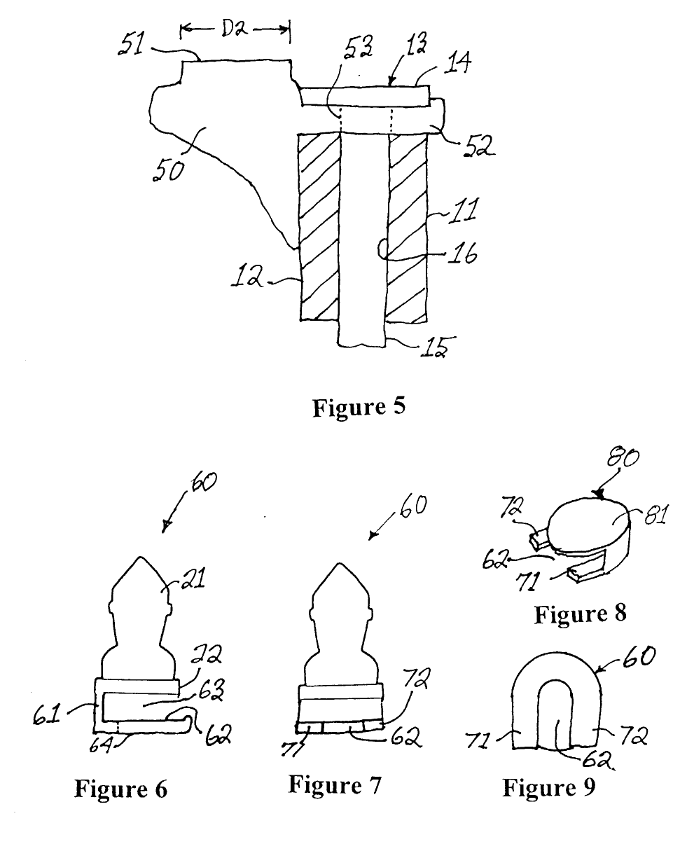

In many hinge assembly installations, the clearance between the expanded head of the hinge pin and the adjacent doorjamb does not permit the attachment of a three-dimensional body thereto. In such an event, an offset adapter 50 may be attached to the hinge assembly to provide a three-dimensional body-mounting surface 51 that is laterally displaced from the expanded head 14 of the hinge pin as shown in FIG. 5. The offset adapter 50 has a flange 52 extending laterally therefrom with a circular aperture 53 therein. To install the offset adapter, the stem 15 of the hinge pin is inserted through the aperture 53 prior to inserting the stem into the cylindrical channel 16. The three-dimensional body 20 is then affixed to the cylindrical three-dimensional body-mounting surface 51 by adhesive means as previously described.

A second preferred embodiment of a three-dimensional body adapted for attachment to a hinge pin is illustrated at numeral 60 in side elevational view in FIG. 6 and rear elevational view in FIG. 7. The three-dimensional body 60 includes a recurved flange 61 attached to the base portion 22. The bottom portion 64 of the flange 61 has a slot 62 therein separating a pair of tines 71 and 72. The flange 61 bounds a recess 63 dimensioned to receive the expanded head of a hinge pin therewithin. To install the second preferred embodiment 60 of the three-dimensional body, the hinge pin is partially removed from the cylindrical channel in the hinge assembly and the slot 62 in the bottom portion 64 is slid over the stem between the expanded head of the hinge pin and the upper end of the hinge pieces such that the expanded head of the hinge pin is contained within recess 63. The hinge pin is then forced down into the cylindrical channel. Traction on the three-dimensional body 60 may be used to manually remove the hinge pin from the assembly.

Alternatively, the base portion of the first preferred embodiment 20 of the three-dimensional body can be affixed to the cylindrical upper surface 81 of a hinge connector such as indicated at numeral 80 in FIG. 8. The subassembly can then be attached to the hinge assembly in the manner of the previous paragraph. The second preferred embodiment 60 of the three-dimensional body of the present invention is shown in bottom view in FIG. 9.

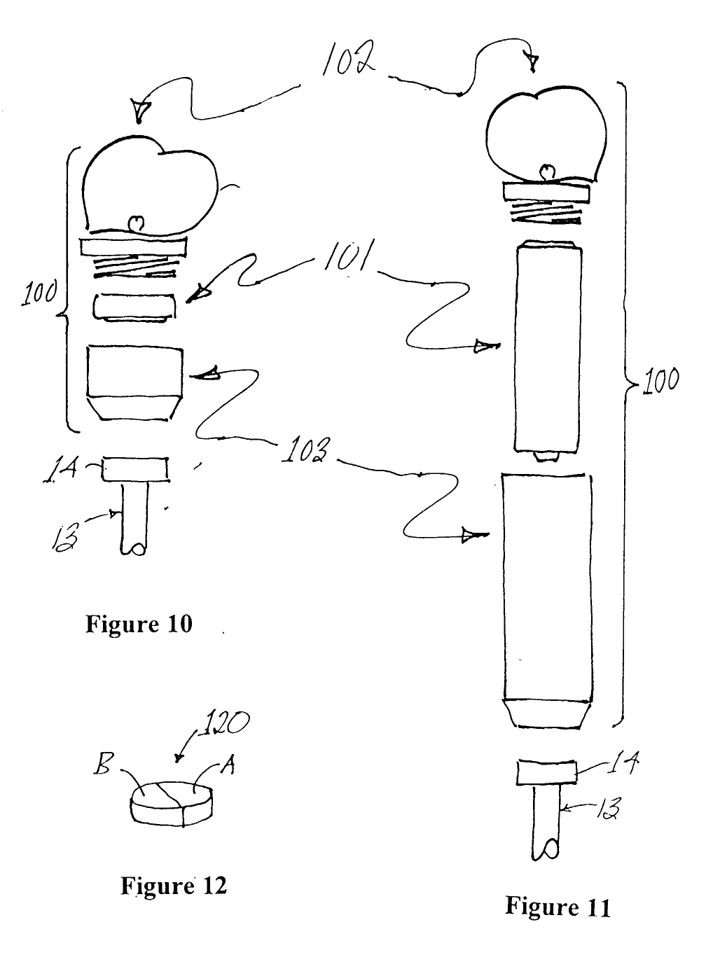

It is desirable in many instances to provide a source of light in a darkened room that indicates the location of a door. The three-dimensional body may include a source of light such as an LED (light emitting diode) and a source of power for the source of light such as a battery. With reference now to FIGS. 10 and 11, a hinge pin-mountable three-dimensional body adapted to provide a source of light is indicated at numeral 100. The three-dimensional body 100 includes a battery 101 and an LED 102. The three-dimensional body may optionally further include either a photosensitive or manual on/off switch (not shown). The base portion 103 of the three-dimensional body is recessed to receive a battery 101 therein. The base portion 103 is separable from the three-dimensional body and includes a battery 101 disposed within the battery compartment. The source of light 102 affixed to the three-dimensional body 100 is in electrical communication with the battery when the base portion is attached to the three-dimensional body. When the three-dimensional body 100 is assembled and affixed to the expanded head 14 of hinge pin 13 by adhesive means as previously discussed, the three-dimensional body may be used as both a means for grasping the hinge pin for removal from the hinge assembly and for providing a source of light.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What I claim is:

1. A device for attachment to a hinge pin comprising a hinge assembly, the hinge pin having an expanded cylindrical head with an outer diameter, the device thereafter providing means for grasping the hinge pin for removal from the hinge assembly, the device comprising a three-dimensional body having a base portion with a cylindrical recess therein, said recess having a recess diameter that is greater than or equal to said outer diameter of said expanded head of said hinge pin, said cylindrical recess being adapted to receive a portion of the expanded head of said hinge pin therewithin.

2. The device of claim 1 further comprising adhesive means operable for affixing said base portion to said expanded head of the hinge pin.

3. The device of claim 2 wherein said base portion is separable from said three-dimensional body and wherein said base portion includes a battery compartment therewithin, a battery disposed within said battery compartment and said three-dimensional body includes a source of light affixed thereto, said source of light being in electrical communication with said battery when said base portion is attached to said three-dimensional body.

4. The device of claim 3 further comprising an on/off switch operable for controlling electrical communication between said battery and said source of light.

5. A hinge pin pulling kit comprising a three-dimensional body having a base portion with a cylindrical recess therein dimensioned to snugly receive a portion of an expanded head of a hinge pin therewithin; and (b) adhesive means operable for affixing said base portion to the expanded head of a hinge pin.

6. The hinge pin pulling kit of claim 5 further comprising a cylindrical adapter having an upper surface dimensioned to be snugly received within said cylindrical recess in said base portion and a bottom opposing surface having a second cylindrical recess therewithin dimensioned to snugly receive the expanded head of the hinge pin therewithin.

7. The hinge pin pulling kit of claim 5 further comprising an offset adaptor, said offset adaptor having a base portion adapted to be attached to a hinge pin and a cylindrical three-dimensional body mounting portion, wherein when said offset adaptor is attached to the hinge pin, the cylindrical three-dimensional body mounting portion is laterally displaced from the expanded head of the hinge pin.

8. A device for attachment to a hinge pin comprising a hinge assembly, the hinge pin having an expanded cylindrical head with an outer diameter, the device thereafter providing means for grasping the hinge pin for removal from the hinge assembly, the device comprising a three-dimensional body having a base portion with a slotted flange depending downwardly from said three-dimensional body, said slotted flange being operable for attachment to said hinge pin.
